(19) United States
(12) Patent Application Publication
(10) Pub. No.: US 2026/0120680 A1
(43) Pub. Date: Apr. 30, 2026

(54) MONITORING FOR TEMPORARY HOTWORD TO MODIFY OR CONFIRM USER QUERY

(71) Applicant: GOOGLE LLC, Mountain View, CA (US)

(72) Inventors: Brett Barros, San Mateo, CA (US); James Flynn, Mountain View, CA (US)

(21) Appl. No.: 19/003,805

(22) Filed: Dec. 27, 2024

Related U.S. Application Data
(60) Provisional application No. 63/615,695, filed on Dec. 28, 2023.

(51) Int. Cl. G10L 15/01; G06F 16/242; G10L 15/08; G10L 15/187; G10L 15/22

(52) U.S. Cl. CPC G10L 15/01; G06F 16/243; G10L 15/187; G10L 15/22; G10L 2015/088; G10L 2015/223; G10L 2015/225

(57) ABSTRACT

Implementations relate to receiving audio data capturing a spoken request directed to an automated assistant, and processing the audio data capturing the spoken request to generate a speech recognition of the spoken request. When the speech recognition of the spoken request is determined to include a mis-transcribed phrase, one or more candidate phrases phonetically similar to the potentially mis-transcribed phrase are determined, and the automated assistant can be transitioned to enter a phonetically restricted listening state in which only audio data capturing one or more of the candidate phrases is monitored for. If a user input that includes or selects a particular candidate phrase, of the one or more candidate phrases, is received, an action that corresponds to the particular candidate phrase, but not corresponding to the potentially mis-transcribed phrase, can be performed.

### BACKGROUND

Humans can engage in human-to-computer dialogs with interactive software applications referred to herein as “automated assistants” (also referred to as “chatbots,” “interactive personal assistants,” “intelligent personal assistants,” “personal voice assistants,” “conversational agents,” or simply “assistant,” etc.). To invoke an automated assistant for human-to-computer dialogs/interactions, humans (who when they interact with automated assistants may be referred to as “users”) often provides a hotword that the automated assistant monitors for (or sometimes by providing other types of input, such as user selection of a graphical interface element that represents the automated assistant). Once invoked, the automated assistant typically enters, and remains in for a short period of time, a general listening state where any audio data captured by a client device via which the automated assistant is accessible, will be processed and/or responded.

In the general listening state, any audio data capturing a spoken utterance of a user can be processed by the automated assistant to generate a response (content or action). However, sometimes, the generated response may not be sufficiently responsive to the spoken utterance in situations where, for instance, the spoken utterance is not confidently/correctly recognized or understood. As an example, the generated response may be the playing of song A while the user audibly requests for song B that sounds phonetically similar to the song A. In this example, the user often has to re-invoke the automated assistant again with the hotword, and provide a more clearly expressed command or request. Invoking the automated assistant multiple times in an intensive manner can prolong interaction of the user with the client device, deteriorate the user's experience, and/or cause excess utilization of battery, processor, and/or other resources of the client device.

### SUMMARY

Implementations disclosed herein relate to transitioning an automated assistant to enter a phonetically restricted listening state when accurate user intent cannot be confidently determined for a received spoken utterance. In the phonetically restricted listening state, the automated assistant monitors for audio data that includes a particular candidate phrase, out of one or more candidate phrases. The one or more candidate phrases can be determined based on being phonetically similar to a phrase that is recognized from the received spoken utterance for which the accurate user intent cannot be confidently determined.

As a non-limited working example, a user of a client device (e.g., an interactive speaker) can provide an utterance of “Assistant, play Madonna on app A” to the client device, where “Assistant” can be detected using an invocation engine as a hotword that invokes an automated assistant installed at the client device. Once invoked, the automated assistant performs speech recognition on the utterance of “Assistant, play Madonna on app A” (or a portion thereof, i.e., “play Madonna on app A”) to generate a speech recognition of the utterance, where the speech recognition can be a mis-transcription (i.e., “Assistant, play My Donna on app A”) of the utterance (“Assistant, play Madonna on app A”). In this case, if the automated assistant further performs natural language understanding of the speech recognition (i.e., “Assistant, play My Donna on app A”), an action (i.e., “play a song named My Donna”) can be determined and performed. However, performing the action (i.e., the playing of the song named “My Donna”) that is determined from the mis-transcription can lead to waste of computational and/or network resources as the provided the utterance to request for a song by the artist “Madonna” as opposed to a song entitled “My Donna”.

Given the above example, implementations disclosed herein can determine, before performing the action of “play a song named ‘My Donna’”, whether the speech recognition includes any potentially mis-transcribed phrase. In response to determining that the speech recognition includes a potentially mis-transcribed phrase, implementations herein can determine one or more candidate phrases that are phonetically similar to the potentially mis-transcribed phrase and cause the automated assistant to enter a phonetically limited listening state where only audio data containing one or more of the candidate phrases is monitored for and/or acted upon if detected. In these implementations, if the user provides an additional utterance that specifies a particular candidate phrase (e.g., “Madonna”), of the one or more candidate phrases, the particular candidate phrase can replace the potentially mis-transcribed phrase (e.g., “My Donna”) to determine/generate an updated action of “play a song by Madonna”. The updated action of “play a song by Madonna” can be performed, instead of performing the action of “play the song named ‘My Donna’”. In these and other manners the correct action can be performed in response to the spoken utterance, thereby conserving computational and/or network resources that would have been wasted from partially or fully performing the incorrect action based on the potentially mis-transcribed phrase. Optionally, initiating performance of an action based on a potentially mis-transcribed phrase can be postponed until after a duration of monitoring, for the candidate phrase(s), has expired. In these and other manners, such action will only be performed in situations where the user does not speak one of the candidate phrase(s) during such monitoring. Accordingly, performance of such action will not occur when the user does speak one of the candidate phrase(s) during such monitoring, but will occur when the user does not speak one of the candidate phrase(s) during such monitoring (which can indicate that the potentially mis-transcribed phrase is indeed correctly transcribed).

Alternatively, in the above example, implementations can still cause the action of “play a song named ‘My Donna’” to be performed, but can pause or terminate the action of “play a song named ‘My Donna’” once the updated action of “play a song by Madonna” is determined or performed. In some implementations, in response to determining that the speech recognition includes the potentially mis-transcribed phrase, a message seeking user input to confirm a command or request in the aforementioned utterance (e.g., “Assistant, play Madonna on app A”) can be generated and/or rendered. For instance, the message can be visually displayed in natural language, asking “What did you want to play?” In this instance, the user can responsively provide the additional utterance of “Ma-don-na” or “No, I said Madonna”, and correspondingly, the song “My Donna” can be paused/terminated and a song by Madonna can then be played. In this instance, in response to determining the one or more candidate phrases that are phonetically similar to the potentially mis-transcribed phrase, the automated assistant can be configured in the aforementioned phonetically limited listening state where only audio data capturing one or more of the candidate phrases is monitored for and/or acted upon.

In some implementations, the message can be generated or rendered in response to determining the one or more candidate phrases that are phonetically similar to the potentially mis-transcribed phrase. The message can alternatively or additionally include one or more selectable elements corresponding to the one or more candidate phrases. For instance, the message can include a first selectable element that displays “Madonna” that, when selected, causes the playing of a song by Madonna. In these implementations, the automated assistant can still be configured in the aforementioned phonetically limited listening state where only audio data capturing one or more of the candidate phrases is monitored for, in response to determining the one or more candidate phrases that are phonetically similar to the potentially mis-transcribed phrase.

By determining whether the speech recognition is mis-transcribed and identifying the potentially mis-transcribed phrase if it's determined that the speech recognition is mis-transcribed, performance of an action determined based on the mis-transcribed speech recognition (i.e., an action not correctly responding to a user request) can be avoided or mitigated, which reduces or avoids unnecessary consumption of the computing resources. By determining the one or more candidate phrases that are phonetically similar to the potentially mis-transcribed phrase and causing the automated assistant in the phonetically limited listening state, excess utilization of battery, processor, and/or other resources of the client device, can be avoided. For instance, the user does not need to repeatedly provide a hotword (e.g., “Assistant”) to invoke the automated assistant for interaction. Nor does the user need to worry about how long the automated assistant remains responsive (e.g., remains in a general listening state where any audio data is monitored and processed by the automated assistant) after being invoked. Further, the phonetically limited listening state can utilize lesser resources (e.g., memory and/or processor resources) than an alternate listening state in which full speech recognition is performed. For example, the phonetically limited listening state can be performed utilizing a lower power digital signal processor (DSP) whereas full speech recognition may be incapable of being performed on the DSP. For instance, the phonetically limited listening state can be performed utilizing dynamic hotword model(s) that are adapted to monitor for only the candidate phrase(s) and that are capable of being utilized via a DSP.

In various implementations, the automated assistant can determine whether the speech recognition includes any mis-transcribed phrase based on speech recognition and/or natural language understanding of the speech recognition (e.g., “Assistant, play My Donna on app A”) of the utterance (e.g., “Assistant, play Madonna on app A”). In some implementations, the automated assistant can include an automatic speech recognition (ASR) engine to process the audio data capturing the utterance (e.g., “Assistant, play Madonna on app A”), to generate the speech recognition (e.g., “Assistant, play My Donna on app A”) of the utterance and one or more ASR scores for the speech recognition. The one or more ASR scores can include, for instance, one or more confidence scores each indicating a degree of transcription (speech recognition) accuracy predicted for a respective word in the speech recognition and/or for the speech recognition as a whole.

As a non-limiting example, the ASR engine can process the aforementioned utterance of “Assistant, play Madonna on app A”, to generate an output (e.g., <Assistant: 90%>, <play: 90%><My Donna: 50%><on app A: 90%>) indicating the speech recognition of the utterance and corresponding ASR score(s). In this example, the automated assistant can determine that the speech recognition of “Assistant, play My Donna on app A” includes a potentially mis-transcribed phrase of “My Donna”, based on an ASR score (confidence score) predicted for “My Donna” being approximately 50%, which is below a predetermined transcription confidence score.

Alternatively or additionally, in some implementations, the automated assistant can include a natural language understanding (NLU) engine. The NLU engine performs natural language understanding on the speech recognition (e.g., “Assistant, play My Donna on app A”) of the utterance (“Assistant, play Madonna on app A”), to determine a user intent (and associated parameters, if there is any), and/or a NLU score predicted for the user intent (and associated parameters, if there is any). In these implementations, the automated assistant can determine that the speech recognition of “Assistant, play My Donna on app A” includes a potentially mis-transcribed phrase of “My Donna”, based on the NLU score indicating that “My Donna” is unlikely requested by the user or “My Donna” is a book that cannot be played, etc.

In various implementations, determining the one or more candidate phrases which are phonetically similar to the potentially mis-transcribed phrase includes: determining a sequence of phonemes that correspond to the potentially mis-transcribed phrase, and determining, based on the sequence of phonemes and/or user data associated with one or more accounts of the user accessible by the automated assistant, the one or more candidate phrases. As a non-limiting example, the one or more candidate phrase can be phonetically similar to the potentially mis-transcribed phrase by having no more than two phonemes that are different from the sequence of phonemes for the potentially mis-transcribed phrase. Alternatively or additionally, the one or more candidate phrases can be at least referenced once from the user data. Alternatively or additionally, the one or more candidate phrase can be required to have an initial phoneme the same as or substantially similar to an initial phoneme, of the sequence of phonemes for the potentially mis-transcribed phrase.

In some implementations, the aforementioned invocation engine can process the audio data of the utterance (“Assistant, play Madonna on app A”) using a machine learning (ML) trained to detect the hotword (“Assistant”), to determine whether the utterance (“Assistant, play Madonna on app A”) includes the hotword (“Assistant”) to invoke the automated assistant.

In some implementations, the automated assistant can include a dynamic hotword detection engine. When in the aforementioned phonetically limited listening state where only audio data capturing one or more of the candidate phrases is monitored for, the dynamic hotword detection engine can be activated to process one or more additional utterances, to determine whether the one or more additional utterances include any of the candidate phrases.

As a non-limiting example, “Madonna” can be determined as the one and only one candidate phrase that is phonetically similar to the potentially mis-transcribed phrase of “My Donna”. In this example, a dynamic hotword detection engine can process the one or more additional utterances using an additional ML model trained to detect the candidate phrase (i.e., “Madonna”). Optionally but not necessarily, in response to detecting the candidate phrase (i.e., “Madonna”) from the one or more additional utterances, the aforementioned ASR engine can process the one or more additional utterances to recognize and confirm the detected candidate phrase (i.e., “Madonna”).

Continuing with the example above, the automated assistant can update the speech recognition of the utterance (or update the aforementioned user intent and/or associated parameters) by replacing the potentially mis-transcribed phrase (i.e., “My Donna”) with the candidate phrase (i.e., “Madonna”). The NLU engine can process the updated speech recognition (“Assistant, play Madonna on app A”) of the utterance (“Assistant, play Madonna on app A”), to determine an updated action of “play a song by Madonna on app A”. The updated action of “play a song by Madonna on app A” can be performed, instead of performing the action of “play a song named My Donna on app A”. Or, if the song named “My Donna” is already being played on app A, such play can be terminated or paused, and a song by Madonna can then be played using the app A.

The above is provided merely as an overview of some implementations. Those and/or other implementations are disclosed in more detail herein.

Various implementations can include a non-transitory computer readable storage medium storing instructions executable by a processor to perform a method such as one or more of the methods described herein. Yet other various implementations can include a system including memory and one or more hardware processors operable to execute instructions, stored in the memory, to perform a method such as one or more of the methods described herein.

### BRIEF DESCRIPTION OF THE DRAWINGS

The above and other aspects, features, and advantages of certain implementations of the present disclosure will be more apparent from the following description taken in conjunction with the accompanying drawings. In the drawings:

FIG. 1A depicts a block diagram of an example environment that demonstrates various aspects of the present disclosure, and in which implementations disclosed herein can be implemented.

FIG. 1B depicts an example process flow that detects and corrects mis-transcription using one or more components illustrated in FIG. 1A, in accordance with various implementations.

FIG. 2A, FIG. 2B, FIG. 2C, and FIG. 2D illustrate a scenario in which an automated assistant identifies mis-transcription of a spoken utterance and thus enables detection of dynamic hotword which is determined based on the mis-transcription, in accordance with various implementations.

FIG. 3A, FIG. 3B, FIG. 3C, and FIG. 3D illustrate a scenario in which an automated assistant identifies mis-transcription of a spoken utterance and thus enables detection of dynamic hotword determined based on the mis-transcription, in accordance with various implementations.

FIG. 4A, FIG. 4B, and FIG. 4C illustrate a scenario in which an automated assistant identifies mis-transcription of a spoken utterance and thus enables detection of dynamic hotword determined based on the mis-transcription, in accordance with various implementations.

FIG. 5A illustrates an example method for facilitating user interaction between a user and an automated assistant, without requiring invocation of the automated assistant using a hotword multiple times, in accordance with various implementations.

FIG. 5B illustrates an example method for facilitating user interaction between a user and an automated assistant, without requiring invocation of the automated assistant using a hotword multiple times, in accordance with various implementations.

FIG. 6 illustrates an example architecture of a computing device, in accordance with various implementations.

### DETAILED DESCRIPTION

The following description with reference to the accompanying drawings is provided for understanding of various implementations of the present disclosure. It's appreciated that different features from different implementations may be combined with and/or exchanged for one another. In addition, those of ordinary skill in the art will recognize that various changes and modifications of the various implementations described herein can be made without departing from the scope and spirit of the present disclosure. Descriptions of well-known or repeated functions and constructions may be omitted for clarity and conciseness.

The terms and words used in the following description and claims are not limited to the bibliographical meanings, and are merely used to enable a clear and consistent understanding of the present disclosure. Accordingly, it should be apparent to those skilled in the art that the following description of various implementations of the present disclosure is provided for the purpose of illustration only and not for the purpose of limiting the present disclosure as defined by the appended claims and their equivalents.

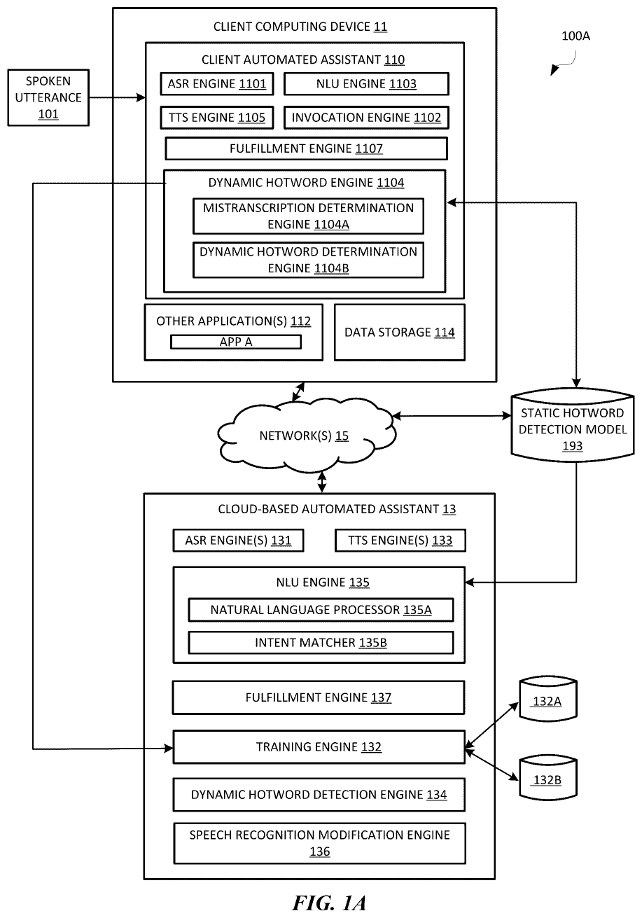

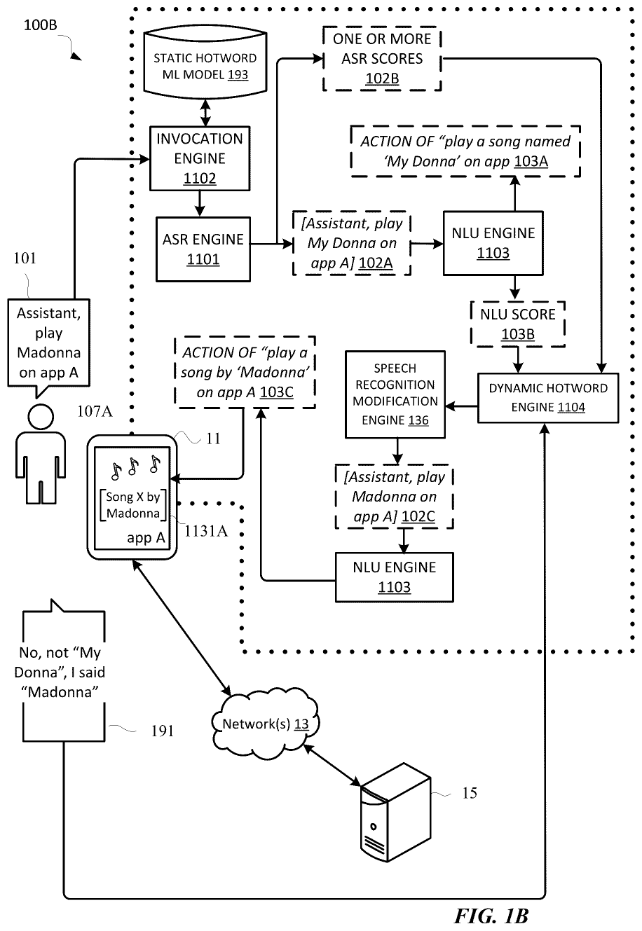

FIG. 1A depicts a block diagram of an example environment that demonstrates various aspects of the present disclosure, and in which implementations disclosed herein can be implemented. As shown in FIG. 1A, the environment 100A can include a client computing device 11 (“client device”) having a client automated assistant 110, one or more networks 15, and a cloud-based automated assistant 13 in communication with the client device 11 via the one or more networks 15. The one or more networks 15 can include, for example, a local area network (LAN), a wide area network (WAN) such as the Internet, and/or any other appropriate network.

The client device 11 can be, for example, a cell phone, a stand-alone interactive speaker, a computer (e.g., laptop, desktop, notebook), a tablet, a robot, a smart appliance (e.g., smart TV), a messaging device, an in-vehicle device (e.g., in-vehicle navigation system or in-vehicle entertainment system), a wearable device (e.g., watch or glasses), a virtual reality (VR) device, an augmented reality (AV) device, or a personal digital assistant (PDA), and the present disclosure is not limited thereto.

In various implementations, the client device 11 can, in addition to being installed with the client automated assistant 110, be further installed with one or more other applications 112 (e.g., app A which can be a messaging application, a browser application, etc.) and include data storage 114.

The client automated assistant 110 can have a plurality of local components including, for example, an automatic speech recognition (ASR) engine 1101, a natural language understanding (NLU) engine 1103, a text-to-speech (TTS) engine 1105, and/or a fulfillment engine 1107. The plurality of local components of the client automated assistant 110 can further include an invocation engine 1102, and/or a dynamic hotword engine 1104. The dynamic hotword engine 1104 can optionally include a dynamic hotword determination engine 1104A.

When the client device 11 is powered on, the client automated assistant 110 is often configured in a hotword restricted listening state in which the invocation engine 1102 is activated to process audio data received via the client device 11. The invocation engine 1102, for instance, accesses a static hotword detection model 193 to process audio data that captures a spoken utterance 101 as input, to generate an output indicating whether the spoken utterance 101 includes a hotword (e.g., “Assistant”). The static hotword detection model 193 can be, for instance, a machine learning model that is trained to detect presence of a particular hotword (e.g., the aforementioned hotword “Assistant”) in a given instance of audio data. The particular hotword can be customized and pre-configured based on a type or function of the automated assistant. In other words, different automated assistants developed by different developers/parties can have different hotwords pre-configured.

By requiring a user to explicitly invoke the client automated assistant 110 using the hotword before the automated assistant can fully process the spoken utterance 101, user privacy can be preserved and resources (computational, battery, etc.) can be conserved. It's noted that, in some cases, the client automated assistant 110 may also be invoked without utilization of the hotword. For instance, the client automated assistant 110 can be invoked in response to a touch gesture, a touch-free gesture, presence detection, and/or a gaze of the user.

In various implementations, the client automated assistant 110 and/or the cloud-based automated assistant 13 can process the audio data that captures the spoken utterance 101 using an ASR model in response to invocation of the client automated assistant 1110. For instance, the ASR engine 1101 of the client automated assistant 110 can process, using the ASR model (not illustrated), the audio data that captures the spoken utterance 101, to generate a speech recognition (may also be referred to as “transcription”) of the spoken utterance 101. As a non-limiting example, the spoken utterance 101 can be “Assistant, play Madonna on app A”.

In the above example, output of the ASR model, in processing the audio data that captures the spoken utterance 101 as input, can be: <Assistant: 90%>, <play: 90%><My Donna: 50%><on app A: 90%>. Such output of the ASR model can indicate the speech recognition of the spoken utterance 101 and/or one or more ASR scores (e.g., “90%” for the phrase “Assistant”, “90%” for the phrase “play”, “50%” for the phrase “My Donna”, and “90%” for the phrase “on app A”). Based on the output of the ASR model, the ASR engine 1101 can generate the speech recognition (“transcription”) of the spoken utterance 101: “Assistant, play My Donna on app A”. In some implementations, the ASR engine 1101 can, based on the output of the ASR model, further determine that the speech recognition (e.g., “Assistant, play My Donna on app A”) of the spoken utterance 101 (“Assistant, play Madonna on app A”) is mis-transcribed. For instance, based on the ASR score (e.g., being approximately “50%”) predicted by the ASR model for the phrase “My Donna” below (“dissatifies”) a predetermined transcription confidence threshold (e.g., 80%), the ASR engine 1101 can determine that the speech recognition (e.g., “Assistant, play My Donna on app A”) of the spoken utterance 101 (“Assistant, play Madonna on app A”) includes a potentially mis-transcribed phrase (e.g., “My Donna”). It's noted that when combined, the client automated assistant 110 and the cloud-based automated assistant 13 can be referred to as “automated assistant”.

The NLU engine 1103 can determine semantic meaning(s) of audio (e.g., the aforementioned audio data capturing the spoken utterance 101) and/or a text (e.g., the aforementioned speech recognition that is converted by the ASR engine 1101 from the audio data), and decompose the determined semantic meaning(s) to determine intent(s) and/or parameter(s) for an assistant action (e.g., generating/displaying responsive content, controlling a third-party device to perform a third-party action). For instance, the NLU engine 1103 can process the speech recognition (e.g., “Assistant, play My Donna on app A”) of the spoken utterance 101 (“Assistant, play Madonna on app A”), to determine an intent (e.g., play music on app A, sometimes referred to as “user intent”) and one or more parameters (e.g., a name of the music, such as “My Donna”, a performer of the music, year of performance of the music, etc.) for the assistant action of “play music/song named ‘My Donna’ on app A”.

In some implementations, the NLU engine 1103 can process, using a NLU machine learning model, the aforementioned speech recognition (e.g., “Assistant, play My Donna on app A”) as input. In processing the aforementioned speech recognition, the NLU machine learning model can generate an output that indicates the aforementioned intent and/or the one or more parameters. Such output of the NLU machine learning model can further indicate or include a NLU score indicating whether the intent (e.g., play <music> on app A) and/or the one or more parameters (e.g., a name of the music, such as “My Donna”) are feasible.

In some implementations, when the NLU score is below a predetermined NLU score threshold, the NLU engine 1103 can determine that the intent (e.g., play music on app A) and/or the one or more parameters (e.g., a name of the music, such as “My Donna”) indicated by the output of the NLU machine learning model, are unresolved or misresolved for the spoken utterance 101 (“Assistant, play Madonna on app A”).

In some implementations, based on the output of the ASR model and/or the output of the NLU machine learning model, the dynamic hotword engine 1104 can cause the automated assistant to enter the aforementioned phonetically restricted listening state. For instance, in response to the NLU engine 1103 determining that the intent (e.g., play music on app A) and/or the one or more parameters (e.g., a name of the music, such as “My Donna”) are unresolved or misresolved for the spoken utterance 101 (“Assistant, play Madonna on app A”) and based on the aforementioned one or more ASR scores and/or the NLU score, the dynamic hotword engine 1104 can determine to transition the automated assistant from the hotword restricted listening state to the phonetically restricted listening state.

In the above case, the dynamic hotword engine 1104 can cause the automated assistant to transition from the hotword restricted listening state (or a general listening state in which any audio data is fully processed) to the phonetically restricted listening state. It's noted that when the automated assistant is in the phonetically limited listening state, the automated assistant only monitors for audio data capturing one or more candidate phrases (sometimes referred to as “dynamic hotword(s)”). A non-limiting example for determining the one or more candidate phrases is described below.

In some implementations, the dynamic hotword engine 1104 can include a mis-transcription determination engine 1104A and a dynamic hotword determination engine 1104B. The mis-transcription determination engine 1104A can identify, based on the aforementioned output of the ASR model, the potentially mis-transcribed phrase (e.g., “My Donna”) for the spoken utterance 101 (“Assistant, play Madonna on app A”). Based on the potentially mis-transcribed phrase (e.g., “My Donna”) identified by the mis-transcription determination engine 1104A, the dynamic hotword determination engine 1104B can determine one or more candidate phrases (e.g., “Madonna”) that are phonetically similar to the potentially mis-transcribed phrase.

In some implementations, the dynamic hotword determination engine 1104B can determine the one or more candidate phrases which are phonetically similar to the potentially mis-transcribed phrase by: determining a sequence of phonemes that correspond to the potentially mis-transcribed phrase, and determining, based on the sequence of phonemes and/or user data associated with one or more accounts of the user accessible by the automated assistant, the one or more candidate phrases. As a non-limiting example, the one or more candidate phrase can be phonetically similar to the potentially mis-transcribed phrase by having no more than two phonemes (or other value of a threshold for the number of phonemes in a candidate phrase that differ from the potentially mis-transcribed phrase, e.g., “1”) that are different from the sequence of phonemes for the potentially mis-transcribed phrase.

Alternatively or additionally, the one or more candidate phrase can be required to be at least referenced once from the user data (e.g., user data from one or more accounts of the user that is associated with applications installed at the client device 11 or that is associated with the client device, stored in the data storage 114). For instance, the dynamic hotword determination engine 1104B can determine the one or more candidate phrases based on a respective candidate phrase being included in the user data for a number of times (e.g., once, twice, or twice per last three months) that exceeds a predefined threshold (frequency threshold or referencing threshold). Alternatively or additionally, the one or more candidate phrase can be required to have an initial phoneme the same as or substantially similar to an initial phoneme, of the sequence of phonemes for the potentially mis-transcribed phrase.

In some implementations, the client device 11, or the cloud-based automated assistant 13, can include a dynamic hotword detection engine 132, where the dynamic hotword detection engine 132 can include, or in communication with, a training engine 134 to train one or more machine learning (ML) models on-the-fly. The aforementioned dynamic hotword determination engine 1104B can transmit the one or more candidate phrases to the training engine 132, and the training engine 132 can acquire training data (e.g., a plurality of instances of audio data each capturing a respective candidate phrase, of the one or more candidate phrases) to train one or more machine learning models.

For instance, the dynamic hotword determination engine 1104B can determine a first candidate phrase and a second candidate phrase that are both substantially (e.g., having only one different phoneme) and phonetically similar to a potentially mis-transcribed phrase that is from a speech recognition of a spoken utterance. The dynamic hotword determination engine 1104B can transmit the first candidate phrase and the second candidate phrase (and/or the potentially mis-transcribed phrase) to the dynamic hotword detection engine 132. The dynamic hotword detection engine 132 can acquire training data to train a first ML model 132A in detecting the first candidate phrase from audio data received by the client device 11. The training data to train the first ML model can include, for instance, one or more instances of audio data that each captures the first candidate phrase.

Similarly, the dynamic hotword detection engine 132 can acquire training data to train a second ML model 132B in detecting the second candidate phrase from audio data received by the client device 11. The training data to train the second ML model can include, for instance, one or more instances of audio data that each captures the second candidate phrase.

As described previously, the automated assistant can be configured in the phonetically restricted listening state. For instance, the automated assistant can be configured in the phonetically restricted listening state in response to the dynamic hotword determination engine 1104B determining the one or more candidate phrases (e.g., the first candidate phrase and the second candidate phrase, or in the aforementioned non-limiting example, the candidate phrase of “Madonna”). As another instance, the automated assistant can be configured in the phonetically restricted listening state in response to the dynamic hotword detection engine 132 acquiring one or more trained ML models, that are trained to detect the one or more candidate phrases (or in response to the dynamic hotword detection engine 132 completes training the aforementioned one or more ML models).

In some implementations, the client device 11, or the cloud-based automated assistant 13, can optionally include a speech recognition modification engine 136. In some implementations, when the automated assistant is in the phonetically restricted listening state where the automated assistant monitors only for audio data capturing the one or more candidate phrases, the client device 11 can receive additional audio data capturing a particular candidate phrase, of the one or more candidate phrases. In these implementations, the speech recognition modification engine 138 can modify/update the speech recognition of the spoken utterance 101 based on the particular candidate phrase captured in the additional audio data. For instance, the speech recognition modification engine 138 can update the speech recognition of the spoken utterance 101 by replacing the potentially mis-transcribed phrase in the speech recognition of the spoken utterance 101 with the particular candidate phrase. In this instance, the speech recognition modification engine 138 can transmit the updated/modified speech recognition to the NLU engine 1103 to determine an updated user intent and/or one or more updated parameters, for performing an updated assistant action.

Alternatively, the dynamic hotword detection engine 132 can directly transmit the detected particular candidate phrase to the NLU engine 1103, for the NLU engine to update the user intent and/or to update the one or more parameters. The updated user intent and/or the updated one or more parameters can be transmitted to the fulfillment engine 1107. The fulfillment engine 1107 can fulfill the updated user intent and/or the updated one or more parameters by performing a corresponding assistant action (e.g., updated action of “play a song named Madonna on app A”) instead of, or in replacement of, performing an originally determined assistant action (e.g., “play a song named ‘My Donna’ on app A”).

As shown in FIG. 1A, the cloud-based automated assistant 13 can have a plurality of counterpart components that are respectively similar to the plurality of components included in the client automated assistant 110. For instance, the cloud-based automated assistant 13 can include one or more cloud-based ASR engines 131, and/or one or more cloud-based text-to-speech (TTS) engines 133 that convert a text (e.g., responsive content of “olay, now playing the song ‘Madonna’, enjoy!”) to a synthesized speech using a particular voice. The synthesized speech, for instance, can be generated by using one or more trained speech synthesis neural network models to process the text. The synthesized speech can be audibly rendered via hardware speaker(s) of the client device 11 (e.g., a stand-alone speaker) or via another device (e.g., a cell phone). The cloud-based automated assistant 13 can further include a cloud-based NLU engine 135, and/or a cloud-based fulfillment engine 137. While being substantially similar to its counterpart in the client automated assistant 110, a corresponding component in the cloud-based automated assistant 13 can be trained more extensively or can possess a stronger computational capability.

In some implementations, instead of or in addition to accessing the aforementioned NLU machine learning model, the cloud-based NLU engine 135 (or the NLU engine 1103) can include a cloud-based natural language processor 135A and a cloud-based intent matcher 135B. Given the updated/modified speech recognition (or in some case, the unmodified speech recognition), the client automated assistant 110 can use the cloud-based natural language processor 135A to process the modified speech recognition, thereby determining semantic meaning(s) of the spoken utterance 101. The natural language processor 135A can, for example, process the modified speech recognition (e.g., “Assistant, play Madonna on app A”) in natural language to generate an annotated output. The annotated output can, for example, include one or more (e.g., all) terms or phrases of the modified speech recognition, and one or more annotations of the modified speech recognition. The one or more annotations can, for example, include one or more first-type annotations that annotate the one or more terms with their grammatical roles (e.g., “noun”, “verb”, “adjective”, “pronoun”, etc.).

Alternatively or additionally, the one or more annotations can include one or more second-type annotations that indicate syntactic relationships (e.g., one term is dependent on another) between the one or more terms in the modified speech recognition. Alternatively or additionally, the one or more annotations can include one or more third-type annotations (e.g., entity tags) that identify one or more entities (e.g., a celebrity, a location, content to be searched, a date, etc.) in the modified speech recognition.

The client automated assistant 110 can use the cloud-based intent matcher 135B to identify an intent from the modified speech recognition. For instance, the cloud-based intent matcher 135B can utilize one or more grammars (or a mapping table stored in the data storage 114) to determine whether the annotated output generated based on the modified speech recognition, corresponds to any grammar, of the one or more grammars. Here, the annotated output can be determined to correspond to a first grammar of the one or more grammars, i.e., “play <music>” (or play<music>by <singer>), with the slot <music> being automatically filled with a slot value “Madonna” from the modified speech recognition. Based on a mapping relationship (i.e., the first grammar being mapped to the first intent) between the first grammar (“play <music>” automatically filled with the slot value of “Madonna”) and a first intent, the cloud-based intent matcher 135B can determine the first intent (e.g., “cause app A to play music”) and corresponding parameters (i.e., the aforementioned updated parameter(s), which can be “music associated with ‘Madonna’”). Based on the first intent and the corresponding parameters, a responsive action of the client automated assistant 110 can be performed, which causes the app A to play music associated with “Madonna”.

In some implementations, as described previously, the NLU engine 1103 may not be able to resolve the intent(s) and/or parameter(s) from the speech recognition of the spoken utterance 101. In this case, prompts can be but does not necessarily need to be generated, to display the one or more candidate phrases (and/or the potentially mis-transcribed phrase), to receive user selection of a candidate phrase of the one or more candidate phrases (or to receive user confirmation of the potentially mis-transcribed phrase). In response to the user selection of the candidate phrase, the speech recognition of the spoken utterance 101 can be modified to generate the aforementioned modified speech recognition. If, however, the user confirms that the speech recognition is correct (and thus no modification is needed) by providing user confirmation that selects the potentially mis-transcribed phrase (e.g., “My Donna”) displayed via a corresponding prompt, the speech recognition of the spoken utterance 101 does not need to be modified and a responsive action of the client automated assistant 110 can be performed, which causes the app A to play music called “My Donna”, instead of the music associated with “Madonna”.

FIG. 1B depicts an example process flow 100B that detects and corrects mis-transcription using one or more components illustrated in FIG. 1A, in accordance with various implementations. As shown in FIG. 1B, a user 1 can provide a spoken utterance 101 (“Assistant, play Madonna on app A”) to the client device 11. The invocation engine 1102 of an automated assistant installed at the client device 11 can process audio data capturing the spoken utterance 101 (“Assistant, play Madonna on app A”) to determine that the spoken utterance 101 includes an invocation phrase (“hotword” or “static hotword”), i.e., “Assistant”, that invokes the automated assistant to fully process the spoken utterance 101. For instance, the invocation engine 1102 can process, the audio data capturing the spoken utterance 101 (“Assistant, play Madonna on app A”), using the static hotword ML model 193.

In response to the invocation engine 1102 determining that the spoken utterance 101 includes the hotword that invokes the automated assistant, the ASR engine 1101 of the automated assistant can process the audio data capturing the spoken utterance 101 (“Assistant, play Madonna on app A”) to generate a speech recognition 102A (“Assistant, play My Donna on app A”) of the spoken utterance 101 (“Assistant, play Madonna on app A”) and/or one or more ASR scores 102B. The speech recognition 102A (“Assistant, play My Donna on app A”) can be processed by the NLU engine 1103 of the automated assistant, to determine an action/intent 103A (and one or more corresponding parameter(s)), i.e., “play music named ‘My Donna’ on app A”(or “cause app A to play a song named ‘My Donna’”). Additionally, the NLU engine 1103 can further determine a NLU score 103B that is associated with feasibility of the intent (“play <music> on app A”) and/or the one or more parameters (a name of the music, “My Donna”).

The dynamic hotword engine 1104 (e.g., via the mis-transcription determination engine 1104A in FIG. 1A) can, based on the one or more ASR scores 102B and/or based on the NLU score 103B, determine whether the speech recognition 102A (“Assistant, play My Donna on app A”) of the spoken utterance 101 (“Assistant, play Madonna on app A”) is mis-transcribed (or includes a potentially mis-transcribed phrase, e.g., “My Donna”). In response to determining that the speech recognition 102A (“Assistant, play My Donna on app A”) of the spoken utterance 101 (“Assistant, play Madonna on app A”) is mis-transcribed, the dynamic hotword engine 1104 (e.g., via the dynamic hotword determination engine 1104B in FIG. 1A) can, determine one or more candidate phrases (e.g., “Madonna”) that are phonetically similar to the potentially mis-transcribed phrase (e.g., “My Donna”).

The dynamic hotword engine 1104 (e.g., via the dynamic hotword determination engine 1104B) can retrieve one or more trained ML models that are respectively trained to detect a respective candidate phrase, of the one or more candidate phrases that are phonetically similar to the potentially mis-transcribed phrase, from additional audio data. Alternatively, the dynamic hotword engine 1104 (e.g., via the dynamic hotword determination engine 1104B) can train one or more ML models (e.g., on-the-fly) to each detect, from additional audio data, a respective candidate phrase, of the one or more candidate phrases. The dynamic hotword engine 1104 can further cause the automated assistant to enter a phonetically restricted listening state in which only audio data capturing one or more of the candidate phrases is monitored and responded.

When the automated assistant is in the phonetically restricted listening state, the client device 11 can receive, from the user 1, an additional spoken utterance 191, e.g., “No, not ‘My Donna’, I said ‘Madonna’”. In response to receiving the additional spoken utterance 191 (“No, not ‘My Donna’, I said ‘Madonna’”), an speech recognition modification engine 136 of the automated assistant can modify the speech recognition 102A (“Assistant, play My Donna on app A”) of the spoken utterance 101 (“Assistant, play Madonna on app A”), to generate a modified speech recognition 102C (e.g., “play Madonna on app A”). The modified speech recognition 102C (“play Madonna on app A”) can be processed to determine an updated action 103C, e.g., “play a song named “Madonna” on app A” or “play a song by “Madonna” on app A”. The updated action 103 can be fulfilled using the fulfillment engine 1107 of the automated assistant. For instance, the fulfillment engine 1107 can cause the app A to be launched at the client device 11, cause an interface 1131A of the app A showing a song X by Madonna to be displayed, and cause the song X to be automatically displayed at the interface of the app A. It's noted that the process in FIG. 1B is not intended to be limiting, and the client device 11 can be in communication with a server device 17 (e.g., having one or more of the cloud-based components of the cloud-based automated assistant 13) via the one or more networks 15.

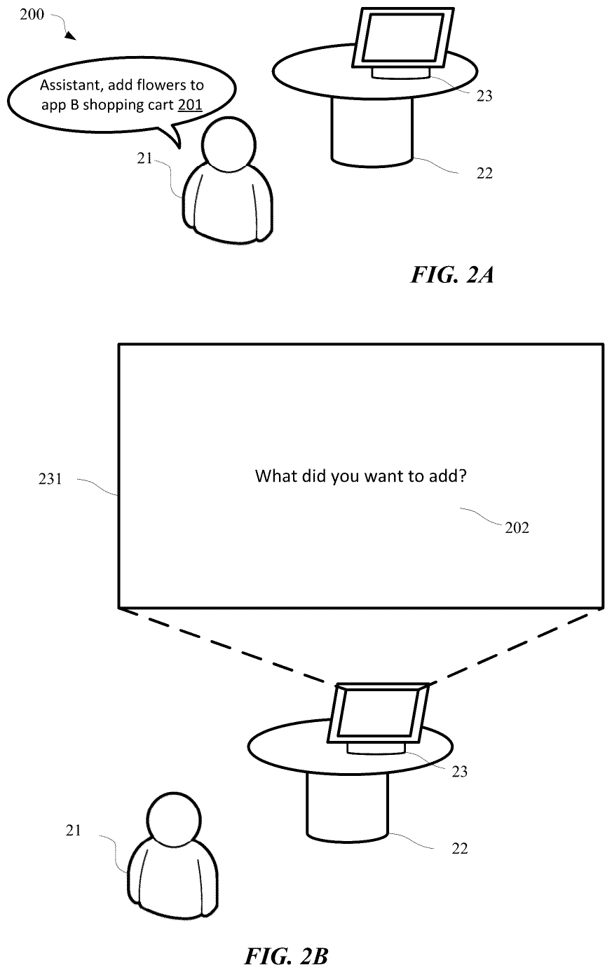

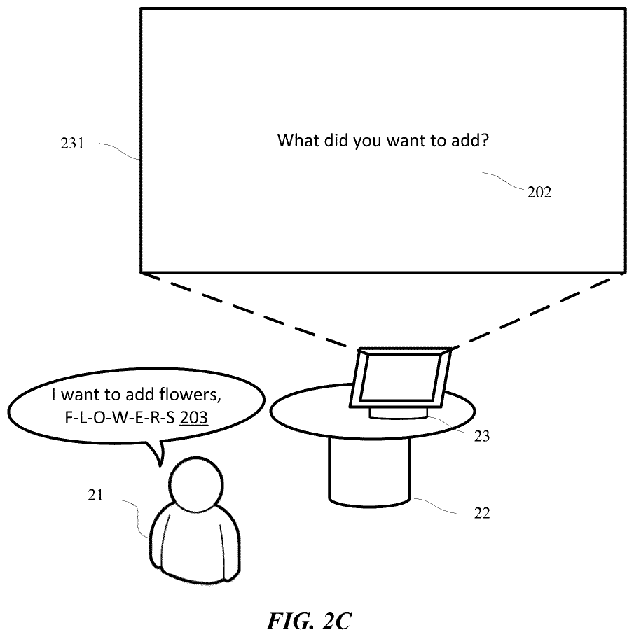

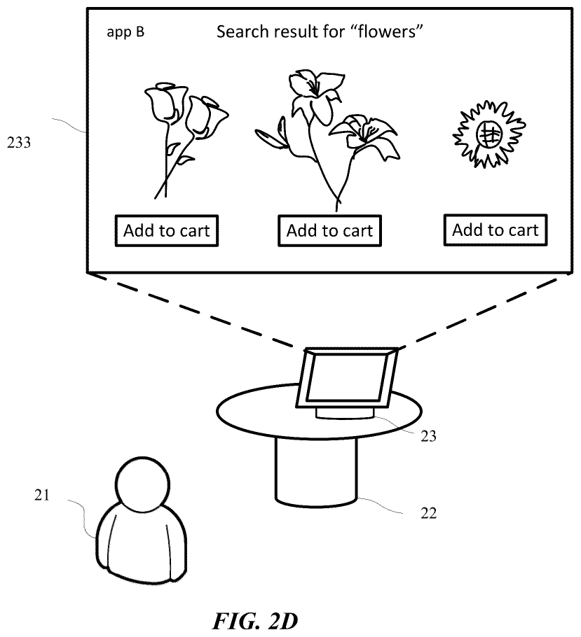

FIG. 2A, FIG. 2B, FIG. 2C, and FIG. 2D illustrate a scenario 200 in which an automated assistant identifies mis-transcription of a spoken utterance and thus enables detection of dynamic hotword determined based on the mis-transcription, in accordance with various implementations. As shown in FIG. 2A, a user 21 can provide a first spoken utterance 201 (“Assistant, add flowers to app B shopping cart”) to a client device 23 that is placed on top of a table 22, where the client device 23 is installed with an automated assistant (e.g., the client automated assistant 110 in FIG. 1A) for interaction with the user 21. In response to receiving the first spoken utterance 201, the automated assistant may be invoked based on detection of the hotword “Assistant” in the first spoken utterance 201, to determine a speech recognition (“Assistant, add flour to app B shopping cart”) for the first spoken utterance 201 (“Assistant, add flowers to app B shopping cart”).

However, the automated assistant may not be confident in accuracy of the speech recognition (“Assistant, add flour to app B shopping cart”) based on performing ASR on the audio data capturing the first spoken utterance 201, and/or based on performing NLU on the speech recognition of the first spoken utterance 201. For instance, the aforementioned mis-transcription determination engine 1104A can determine, based on one or more ASR scores (e.g., a ASR score for phrase “flour” being approximately 60%) and/or a NLU score, that the speech recognition of the first spoken utterance 201 includes a potentially mis-transcription phrase (“flour”). In response, one or more candidate phrases phonetically similar to the potentially mis-transcription phrase can be determined, and the automated assistant can enter a phonetically restricted listening state in which only audio data capturing one or more of the candidate phrases is monitored and responded.

Optionally, as shown in FIG. 2B, the automated assistant can generate, in response to the mis-transcription determination engine determining that the speech recognition of the first spoken utterance 201 is mis-transcribed, a message 202 (“What did you want to add?” or “What did you want to add, flour?”), and/or one or more candidate phrases (e.g., a first candidate phrase “flowers”, a second candidate phrase “flower”). The message 202 can be displayed at an interface 231 of the client device 23. Referring to FIG. 2C, the user 21 can respond to the message 202 by providing a second spoken utterance 203 (“I want to add flowers, F-L-O-W-E-R-S.”). In response to receiving the second spoken utterance 203, a dynamic hotword detection engine of the automated assistant can detect a presence of a particular candidate phrase (“flowers”) in the second spoken utterance 203. It's noted that, if instead of the second spoken utterance 203 (“I want to add flowers, F-L-O-W-E-R-S.”), the user 21 provides an utterance such as “I now want to add eggs”, such utterance may not be processed since no candidate phrase phonetically similar to the potentially mis-transcription phrase (“flour”) is detected from the utterance (“I now want to add eggs”).

In some implementations, the automated assistant can modify the speech recognition (“Assistant, add flour to app B shopping cart”) to generate a modified speech recognition (“Assistant, add flowers to app B shopping cart”), by replacing the potentially mis-transcription phrase (“flour”) with the particular candidate phrase (“flowers”) in the speech recognition (“Assistant, add flour to app B shopping cart”). Alternatively or additionally, the second spoken utterance 203 can be transcribed, where a transcription of the second spoken utterance 203 can be applied to modify the speech recognition (“Assistant, add flour to app B shopping cart”) of the first spoken utterance 201.

Referring to FIG. 2D, based on the modified speech recognition (“Assistant, add flowers to app B shopping cart”), the automated assistant can perform one or more automated assistant actions (“assistant action(s)”). The one or more automated assistant actions can include a first automated assistant action that causes the app B to be launched at the client device 23, a second automated assistant action that searches the app B for “flowers”, and a third automated assistant action of causing an interface 233 of the app B that shows a research result of “flowers” to be displayed at the client device 23, for the user 21 to add a particular type of flowers to the shopping cart of app B. For instance, the user 21 can select to add “roses”, “lily”, or “sunflower” to a shopping cart of the app B, using “add to cart” buttons displayed at the interface 233.

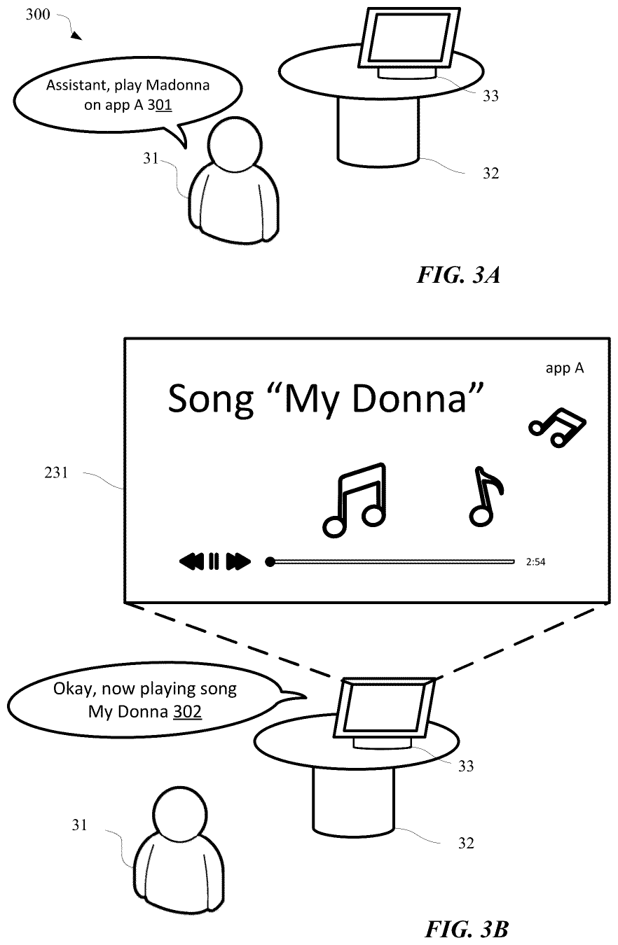

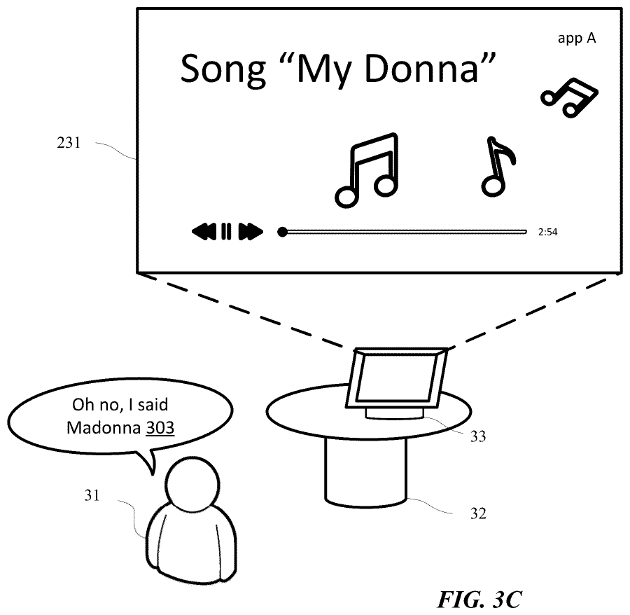

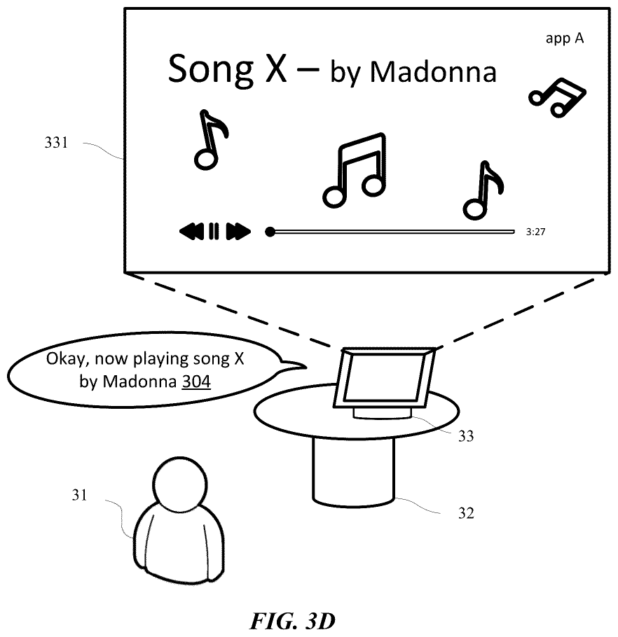

FIG. 3A, FIG. 3B, FIG. 3C, and FIG. 3D illustrate a scenario 300 in which an automated assistant identifies mis-transcription of a spoken utterance and thus enables detection of dynamic hotword determined based on the mis-transcription, in accordance with various implementations. As shown in FIG. 3A, a user 31 can provide a first spoken utterance 301 (“Assistant, play Madonna on app A”) to a client device 33 that is placed on top of a table 32, where the client device 33 is installed with an automated assistant (e.g., the client automated assistant 110 in FIG. 1A) for interaction with the user 31. In response to receiving the first spoken utterance 301, the automated assistant may be invoked based on detection of the hotword “Assistant” in the first spoken utterance 301, to continue determining a speech recognition (“Assistant, play My Donna on app A”) of the first spoken utterance 301 (“Assistant, play Madonna on app A”).

The automated assistant can further perform natural language understanding (NLU) on the speech recognition (“Assistant, play My Donna on app A”) of the first spoken utterance d01, to determine an action (i.e., a third-party action) of “play song ‘My Donna’ using app A”. As shown in FIG. 3B, the automated assistant can cause the action of “play song ‘My Donna’ using app A” to be performed via the client device 33, and/or generate and cause an audio message 302 (“Okay, now playing song ‘My Donna’”) to be audibly delivered to the user 31.

In some implementations, a mis-transcription determination engine (e.g., 1104A in FIG. 1A) can determine, based on one or more ASR scores (e.g., a ASR score for phrase “My Donna” being approximately 50%) generated during speech recognition and/or a NLU score generated during natural language understanding, that the speech recognition of the first spoken utterance 301 includes a potentially mis-transcription phrase (“My Donna”). In response, a particular candidate phrase (“Madonna”) phonetically similar to the potentially mis-transcription phrase can be determined, and the automated assistant can enter a phonetically restricted listening state in which only audio data capturing the particular candidate phrase (“Madonna”) is monitored and responded.

As shown in FIG. 3C, upon listening to the song “My Donna” and while the automated assistant is in the phonetically restricted listening state, the user 31 can provide a second spoken utterance 303 (“Oh no, I said Madonna”). In this case, the automated assistant can process audio data received by the client device 33 and capturing the second spoken utterance 303 (“Oh no, I said Madonna”), to determine that the particular candidate phrase (may also be referred to as “dynamic hotword”, “dynamic hot phrase”, “temporary hotword”, etc.) is detected from the second spoken utterance 303 (“Oh no, I said Madonna”). Correspondingly, an updated action (i.e., an updated third-party action) of “play a song by ‘Madonna’ using app A” can be determined. To perform the updated action of “play a song by ‘Madonna’ using app A”, the automated assistant can perform one or more assistant actions, such as launching the app A at the client device 33, perform a search of a song by “Madonna” within the app A, and select song X by “Madonna”to be played using app A.

The automated assistant can cause the action of “play a song by ‘Madonna’ using app A” to be performed via the client device 33. As shown in FIG. 3D, the automated assistant can cause song X by “Madonna” to be performed using app A installed at the client device 33, and/or generate and cause an additional audio message 304 (“Okay, now playing song X by Madonna”) to be audibly delivered to the user 31.

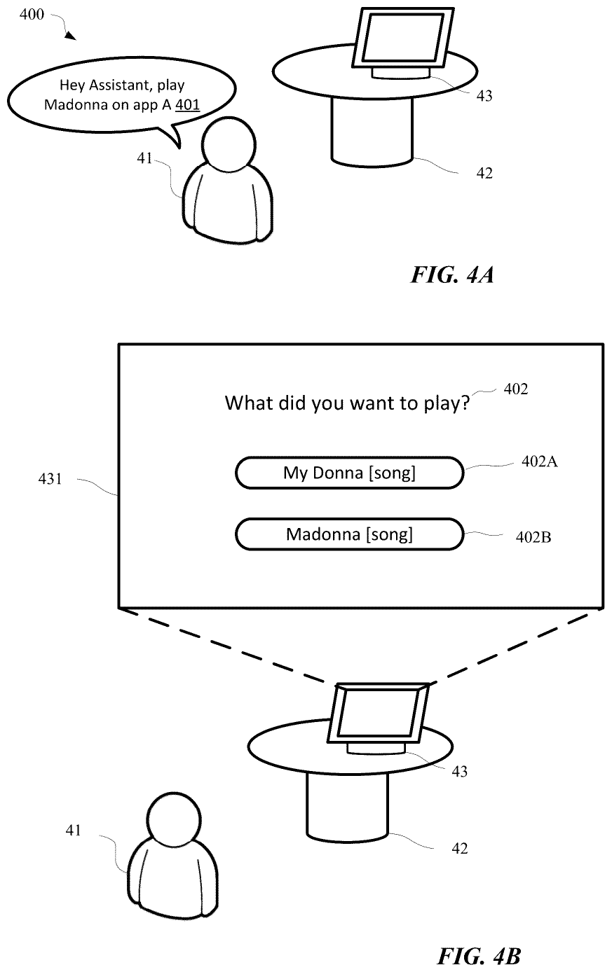

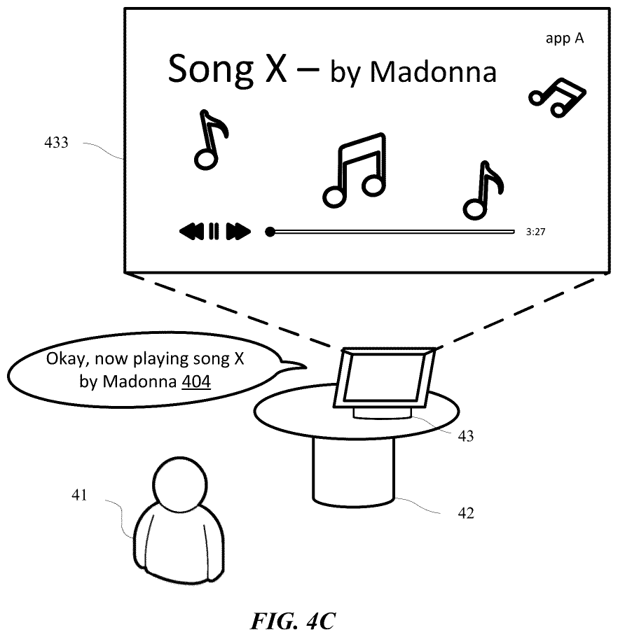

FIG. 4A, FIG. 4B, and FIG. 4C illustrate a scenario 400 in which an automated assistant identifies mis-transcription of a spoken utterance and thus enables detection of dynamic hotword determined based on the mis-transcription, in accordance with various implementations. As shown in FIG. 4A, a user 41 can provide a first spoken utterance 401 (“Hey Assistant, play Madonna on app A”) to a client device 43 that is placed on top of a table 42, where the client device 43 is installed with an automated assistant (e.g., the client automated assistant 110 in FIG. 1A) for interaction with the user 41. In response to receiving the first spoken utterance 401, the automated assistant may be invoked based on detection of the hotword “Hey Assistant” in the first spoken utterance 401, to continue determining a speech recognition (“Hey Assistant, play My Donna on app A”) of the first spoken utterance 401 (“Assistant, play Madonna on app A”).

The automated assistant can further perform natural language understanding (NLU) on the speech recognition (“Hey Assistant, play My Donna on app A”) of the first spoken utterance 401, to determine an action (i.e., a third-party action) of “play song ‘My Donna’ using app A”. Additionally, a mis-transcription determination engine (e.g., 1104A in FIG. 1A) of the automated assistant can determine, based on one or more ASR scores (e.g., a ASR score for phrase “My Donna” being approximately 50%) generated during speech recognition and/or a NLU score generated during natural language understanding, that the speech recognition of the first spoken utterance 401 includes a potentially mis-transcription phrase (“My Donna”).

In response to the automated assistant (e.g., via the mis-transcription determination engine) determining that the speech recognition of the first spoken utterance 401 includes the potentially mis-transcription phrase (“My Donna”), the automated assistant can (1) further determine a particular candidate phrase (“Madonna”) phonetically similar to the potentially mis-transcription phrase and (2) cause the automated assistant to enter a phonetically restricted listening state in which only audio data capturing the particular candidate phrase (“Madonna”) is monitored and responded.

Alternatively or additionally, as shown in FIG. 4B, in response to determining that the speech recognition of the first spoken utterance 401 includes the potentially mis-transcription phrase (“My Donna”), the automated assistant can generate a message 402 (“What did you want to play?”) and cause the message 402 to be displayed at an interface 431 of the client device 43. Referring again to FIG. 4B, the automated assistant can further use an interface element generation engine to generate a first selectable element 402A for the particular candidate phrase (“Madonna”), and/or a second selectable element 402B for the potentially mis-transcription phrase (“My Donna”). The automated assistant can cause the first selectable element 402A to be displayed at the interface 431, and/or cause the second selectable element 402B to be displayed at the interface 431, for user selection by the user 41.

As shown in FIG. 4C, in response to the user 41 selects the second selectable element 402B that corresponds to the particular candidate phrase (“Madonna”), a song (e.g., song X) by Madonna can be played using app A via an interface 433 of the client device 43. Optionally, the automated assistant can further audibly render an audible message 404 (“Okay, now playing song x by Madonna”) before the song X played using the app A.

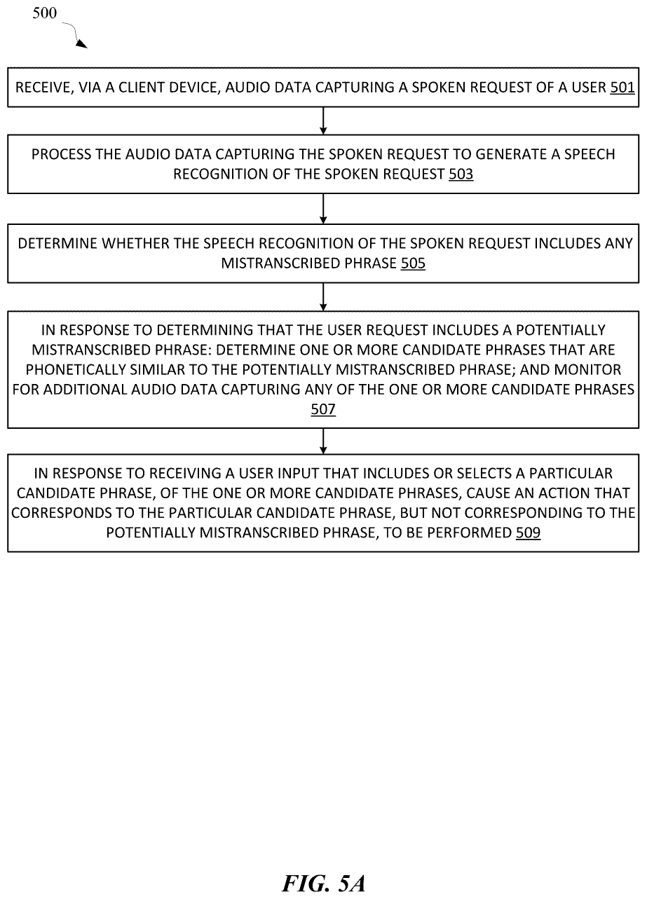

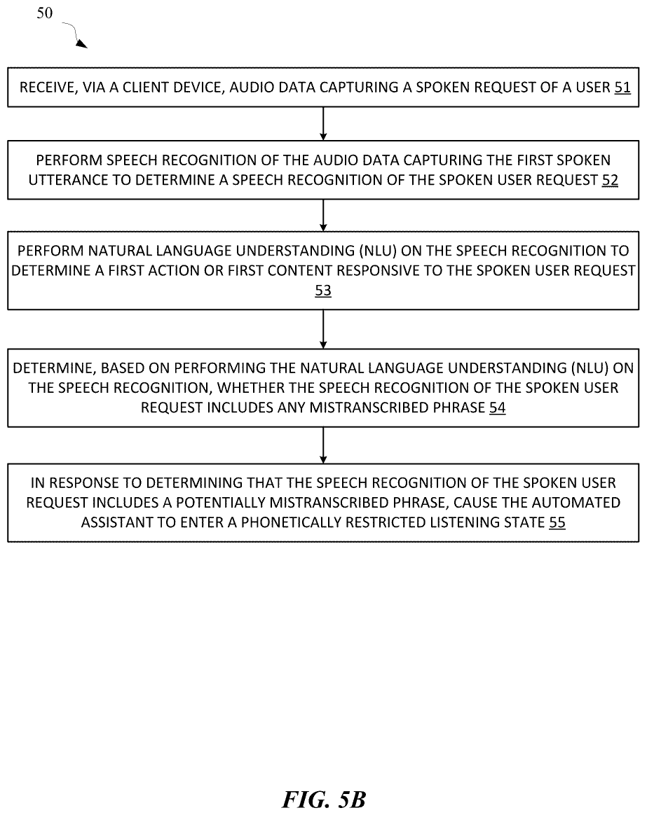

FIG. 5A is a flowchart illustrating an example method 500 for facilitating user interaction between a user and an automated assistant, without requiring invocation of the automated assistant using a hotword multiple times, in accordance with various implementations. For convenience, the operations of the method 500 are described with reference to a system that performs the operations. The system of method 500 includes one or more processors and/or other component(s) of a client device and/or of a server device. Moreover, while operations of the method 500 are shown in a particular order, this is not meant to be limiting. One or more operations may be reordered, omitted, or added.

Referring to FIG. 5A, in various implementations, at block 501, the system can receive, via a client device, audio data capturing a spoken request of a user. Optionally, prior to receiving the audio data capturing the spoken request of the user, an automated assistant (e.g., client automated assistant 110 in FIG. 1A) of the system installed at a client device (e.g., 11 in FIG. 1A) can be configured in a hotword restricted listening state (“sleep mode”) in which only audio data capturing a hotword (static/predetermined) is monitored for. The spoken request can, for instance, include an invocation phrase (“hotword”) that invokes the automated assistant to fully process the spoken request (e.g., “Assistant, play Madonna on app A”).

In various implementations, at block 503, the system can process the audio data capturing the spoken request to generate a speech recognition of the spoken request. In some implementations, an ASR engine (e.g., 1101 in FIG. 1A) of the automated assistant can perform ASR on the spoken request (e.g., “Assistant, play Madonna on app A”) to generate a corresponding speech recognition (e.g., “Assistant, play My Donna on app A”).

In some implementations, the system can process the audio data capturing the spoken request, to generate a speech recognition score for each word in the speech recognition of the spoken request. In these implementations, the system can determine whether the speech recognition of the spoken request includes any mis-transcribed phrase, based on the speech recognition score for each word in the speech recognition of the spoken request.

In various implementations, at block 505, the system can determine whether the speech recognition of the spoken request includes any mis-transcribed phrase (e.g., “My Donna”, while the user says “Madonna”).

In some implementations, the system can determine whether the speech recognition of the spoken request includes any mis-transcribed phrase by: performing natural language understanding (NLU) on the speech recognition of the spoken request to generate a NLU score, and further determine whether the speech recognition of the spoken request includes any mis-transcribed phrase based on the NLU score and/or the speech recognition score for each word in the speech recognition of the spoken request.

In various implementations, at block 507, in response to determining that the user request includes a potentially mis-transcribed phrase, the system can i) determine one or more candidate phrases (e.g., including “Madonna”) that are phonetically similar to the potentially mis-transcribed phrase (“My Donna”), and ii) monitor for additional audio data capturing any of the one or more candidate phrases that are phonetically similar to the potentially mis-transcribed phrase.

Optionally, in some implementations, in response to determining that the user request includes the potentially mis-transcribed phrase, th system can further generate one or more selectable elements each displaying a respective candidate phrase from the one or more candidate phrases, and cause the one or more selectable elements to be visually displayed to the user. In these implementations, the aforementioned user input can be a user selection of a selectable element, of the one or more displayed selectable elements, that displays the particular candidate phrase.

In various implementations, at block 509, in response to receiving a user input that includes or selects a particular candidate phrase, of the one or more candidate phrases, the system can cause an action that corresponds to the particular candidate phrase, but not corresponding to the potentially mis-transcribed phrase, to be performed. Optionally, in some implementations, the user input can be an additional spoken request that includes the particular candidate phrase.

FIG. 5B is a flowchart illustrating an example method 50 for facilitating user interaction between a user and an automated assistant, without requiring invocation of the automated assistant using a hotword multiple times, in accordance with various implementations. For convenience, the operations of the method 50 are described with reference to a system that performs the operations. The system of method 50 includes one or more processors and/or other component(s) of a client device and/or of a server device. Moreover, while operations of the method 50 are shown in a particular order, this is not meant to be limiting. One or more operations may be reordered, omitted, or added.

Referring to FIG. 5B, in various implementations, at block 51, the system can receive, via a client device, audio data capturing a spoken user request of a user.

In various implementations, at block 52, the system can perform speech recognition of the audio data capturing the first spoken utterance to determine a speech recognition of the spoken user request.

In various implementations, at block 53, the system can perform natural language understanding (NLU) on the speech recognition to determine a first action or first content responsive to the spoken user request.

In various implementations, at block 54, the system can determine, based on performing the natural language understanding (NLU) on the speech recognition, whether the speech recognition of the spoken user request includes any mis-transcribed phrase.

In various implementations, at block 55, the system can, in response to determining that the speech recognition of the spoken user request includes a potentially mis-transcribed phrase, cause the automated assistant to enter a phonetically restricted listening state. In the phonetically restricted listening state, the automated assistant monitors, via the client device, for audio data including one or more candidate phrases that are phonetically similar to the potentially mis-transcribed phrase.

In some implementations, optionally, the system can receive, via the client device, additional audio data capturing a spoken utterance. The system can further process the additional audio data capturing the spoken utterance, to determine that the spoken utterance includes a particular candidate phrase, of the one or more candidate phrases, that is phonetically similar to the potentially mis-transcribed phrase. In response to determining that spoken utterance includes the particular candidate phrase that is phonetically similar to the potentially mis-transcribed phrase, the system can determine, based on the speech recognition of the spoken user request and the particular candidate phrase, a second action that is different from the first action and that is responsive to the spoken user request.

Alternatively or additionally, the system can determine, based on the speech recognition of the spoken user request and the particular candidate phrase, second content that is different from the first content and that is responsive to the spoken user request. In some implementations, optionally, the system can cause the second action to be performed, or the second content to be displayed.

In some implementations, the system can determine the second action or the second content by: replacing, in the speech recognition of the spoken user request, the potentially mis-transcribed phrase with the particular candidate phrase, to generate a user query (or modified speech recognition); and determining the second action or the second content based on the generated user query.

In some implementations, the system can optionally cause the first action to be performed, or the first content to be displayed; and generate a message asking for confirmation of the spoken user request, or a messaging asking for confirmation of the first action or the first content. The message can be rendered via the client device prior to receiving the additional audio data capturing the spoken utterance. In these implementations, the system can pause or terminate the first action prior to causing the second action to be performed. Or, the system can cause the first content to disappear prior to causing the second content to be displayed.

In some implementations, performing natural language understanding (NLU) of the speech recognition can result in one or more NLU scores being generated for the speech recognition. In these implementations, the system can determine whether the speech recognition of the spoken user request includes any mis-transcribed phrase based on the one or more NLU scores.

In some implementations, performing speech recognition of the audio data capturing the spoken user request can result in one or more speech recognition (ASR) scores being generated for the speech recognition. In these implementations, the system can determine whether the speech recognition of the spoken user request includes any mis-transcribed phrase based on the one or more speech recognition scores, and/or based on the one or more NLU scores.

In some implementations, the system can determine the one or more candidate phrases that are phonetically similar to the potentially mis-transcribed phrase based on a sequence of phonemes of the potentially mis-transcribed phrase.

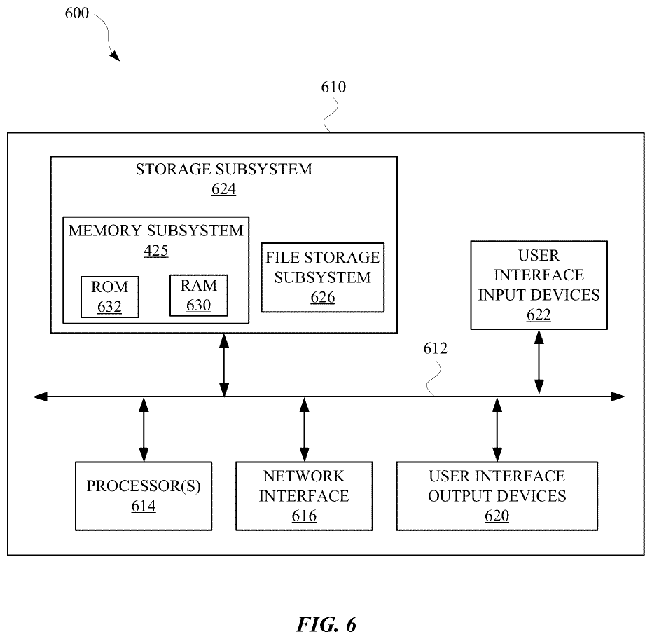

FIG. 6 is a block diagram of an example computing device 610 that may optionally be utilized to perform one or more aspects of techniques described herein. In some implementations, one or more of a client computing device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIG. 1A.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple buses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

Different features of the examples can be combined or interchanged, unless they are not combinable nor interchangeable.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, and/or method described herein. In addition, any combination of two or more such features, systems, and/or methods, if such features, systems, and/or methods are not mutually inconsistent, is included within the scope of the present disclosure.

What is claimed is:

1. A method implemented by one or more processors, the method comprising:
receiving, via a client device, audio data capturing a spoken request of a user;
processing the audio data capturing the spoken request to generate a speech recognition of the spoken request;
determining whether the speech recognition of the spoken request includes any mis-transcribed phrase;
in response to determining that the user request includes a potentially mis-transcribed phrase,
determining one or more candidate phrases that are phonetically similar to the potentially mis-transcribed phrase, and
monitoring for additional audio data capturing any of the one or more candidate phrases that are phonetically similar to the potentially mis-transcribed phrase; and
in response to receiving a user input that includes or selects a particular candidate phrase, of the one or more candidate phrases,
causing an action that corresponds to the particular candidate phrase, but not corresponding to the potentially mis-transcribed phrase, to be performed.

2. The method of claim 1, wherein the user input is an additional spoken request that includes the particular candidate phrase.

3. The method of claim 1, further comprising:
in response to determining that the user request includes a potentially mis-transcribed phrase,
generating one or more selectable elements each displaying a respective candidate phrase from the one or more candidate phrases, and
causing the one or more selectable elements to be visually displayed to the user.

4. The method of claim 3, wherein the user input is a user selection of a selectable element, of the one or more displayed selectable elements, that displays the particular candidate phrase.

5. The method of claim 1, wherein
processing the audio data capturing the spoken request to generate a speech recognition of the spoken request comprises:
generating a speech recognition score for each word in the speech recognition of the spoken request, and
determining whether the speech recognition of the spoken request includes any mis-transcribed phrase comprises:
determining whether the speech recognition of the spoken request includes any mis-transcribed phrase based on the speech recognition score for each word in the speech recognition of the spoken request.

6. The method of claim 1, wherein
determining whether the speech recognition of the spoken request includes any mis-transcribed phrase comprises:
performing natural language understanding (NLU) on the speech recognition of the spoken request to generate a NLU score, and
determining whether the speech recognition of the spoken request includes any mis-transcribed phrase based on the NLU score.

7. A method implemented by one or more processors, the method comprising:
receiving, via a client device, audio data capturing a spoken user request of a user;
performing speech recognition of the audio data capturing the first spoken utterance to determine a speech recognition of the spoken user request;
performing natural language understanding (NLU) of the speech recognition to determine a first action or first content responsive to the spoken user request;
determining, based on performing the natural language understanding (NLU) of the speech recognition, whether the speech recognition of the spoken user request includes any mis-transcribed phrase; and
in response to determining that the speech recognition of the spoken user request includes a potentially mis-transcribed phrase, causing the automated assistant to enter a phonetically restricted listening state,
wherein in the phonetically restricted listening state, the automated assistant monitors, via the client device, for audio data including one or more candidate phrases that are phonetically similar to the potentially mis-transcribed phrase.

8. The method of claim 7, further comprising:
receiving, via the client device, additional audio data capturing a spoken utterance;
processing the additional audio data capturing the spoken utterance to determine that the spoken utterance includes a particular candidate phrase, of the one or more candidate phrases, that is phonetically similar to the potentially mis-transcribed phrase; and
in response to determining that spoken utterance includes the particular candidate phrase that is phonetically similar to the potentially mis-transcribed phrase,
determining, based on the speech recognition of the spoken user request and the particular candidate phrase, a second action that is different from the first action, or second content that is different from the first content, as being responsive to the spoken user request, and
causing the second action to be performed, or the second content to be displayed.

9. The method of claim 8, wherein determining the second action or the second content comprises:
replacing, in the speech recognition of the spoken user request, the potentially mis-transcribed phrase with the particular candidate phrase, to generate a user query, and
determining the second action or the second content based on the generated user query.

10. The method of claim 8, further comprising:
causing the first action to be performed, or the first content to be displayed,
generating a message asking for confirmation of the spoken user request, or a messaging asking for confirmation of the first action or the first content, and
causing the message to be rendered via the client device prior to receiving the additional audio data capturing the spoken utterance.

11. The method of claim 10, further comprising:
pausing or terminating the first action prior to causing the second action to be performed, or
causing the first content to disappear prior to causing the second content to be displayed.

12. The method of claim 7, wherein:
performing natural language understanding (NLU) of the speech recognition comprises: performing natural language understanding of the speech recognition to generate one or more NLU scores for the speech recognition, and
determining whether the speech recognition of the spoken user request includes any mis-transcribed phrase is based on the one or more NLU scores.

13. The method of claim 7, wherein:
performing speech recognition of the audio data capturing the spoken user request comprises: performing speech recognition of the audio data capturing the spoken user request to generate one or more speech recognition scores for the speech recognition, and
determining whether the speech recognition of the spoken user request includes any mis-transcribed phrase is further based on the one or more speech recognition scores.

14. The method of claim 7, further comprising:
determining the one or more candidate phrases that are phonetically similar to the potentially mis-transcribed phrase based on a sequence of phonemes of the potentially mis-transcribed phrase.

15. A method implemented by one or more processors, the method comprising:
receiving, via a client device, audio data capturing a spoken user request of a user;
processing the audio data capturing the spoken user request to generate a speech recognition of the spoken user request;
performing natural language understanding of the speech recognition of the spoken user request, to determine (1) a particular action corresponding to the spoken user request, and (2) whether the spoken user request is mis-transcribed to include a potentially mis-transcribed phrase;
in response to determining that the spoken user request is mis-transcribed, causing the automated assistant to enter a phonetically restricted listening state,
wherein in the phonetically restricted listening state, the automated assistant monitors, via the client device, for audio data including one or more candidate phrases that are phonetically similar to the potentially mis-transcribed phrase;
receiving, via the client device, additional audio data capturing a particular candidate phrase, of the one or more candidate phrases;
determining, based on the speech recognition of the spoken user request and based on the particular candidate phrase, an updated action that is at least partially different from the particular action; and
causing the updated action to be performed.

16. The method of claim 15, wherein determining the updated action comprises:
replacing, in the speech recognition of the spoken user request, the potentially mis-transcribed phrase with the particular candidate phrase, to generate a user query, and
determining the updated action based on the generated user query.

17. The method of claim 15, further comprising:
generating a message asking for confirmation of the spoken user request or the particular action, and
causing the message to be rendered via the client device prior to receiving the additional audio data capturing the spoken utterance.

18. The method of claim 15, wherein:
performing natural language understanding (NLU) of the speech recognition comprises: performing natural language understanding of the speech recognition to generate one or more NLU scores for the speech recognition, and
determining whether the spoken user request is mis-transcribed based on the one or more NLU scores.

19. The method of claim 15, wherein:
processing the audio data capturing the spoken user request comprises: performing speech recognition of the audio data capturing the spoken user request to generate one or more speech recognition scores for the spoken user request, and
determining whether the spoken user request is mis-transcribed based on the one or more speech recognition scores.

20. The method of claim 15, further comprising:
determining the one or more candidate phrases that are phonetically similar to the potentially mis-transcribed phrase based on a sequence of phonemes of the potentially mis-transcribed phrase.
